(19) United States
(12) Patent Application Publication
(10) Pub. No.: US 2002/0004456 A1
(43) Pub. Date: Jan. 10, 2002

(54) IMAGE BEARING MEDIUM

(76) Inventors: EIJI YAMAKAWA, SANDA-SHI (JP); HIDEAKI UEDA, KISHIWADA-SHI (JP); KIYOFUMI HASHIMOTO, SUITA-SHI (JP)

Correspondence Address: SIDLEY AUSTIN BROWN & WOOD, 717 NORTH HARWOOD, SUITE 3400, DALLAS, TX, 75201, US

(21) Appl. No.: 09/276,354

(22) Filed: Mar. 25, 1999

(30) Foreign Application Priority Data
Mar. 30, 1998 (JP) 10-84723
Mar. 30, 1998 (JP) 10-84724
Mar. 30, 1998 (JP) 10-84725

(51) Int. Cl. B41M 5/26

(52) U.S. Cl. 503/200

(57) ABSTRACT

An image bearing medium which has a flexible substrate and an image bearing layer disposed on the substrate. The image bearing layer contains a low molecular compound which selectively exhibits a solid phase and a thermosensible cholesteric liquid crystal phase. The low molecular compound, when changing its temperature rapidly, changes from the thermosensible cholesteric liquid crystal phase to the solid phase keeping the state in the thermosensible cholesteric phase.

This application is based on applications No. 10-84723, No. 10-84724 and No. 10-84725 filed in Japan, the contents of which are hereby incorporated by reference.

### BACKGROUND OF THE INVENTION

1. Field of the Invention

The present invention relates to an image bearing medium, and more particularly to an image bearing medium which image information can be written on and erased from.

2. Description of Related Art

Leuco dyes with a developer and a subtractive agent, organic low molecular liquid crystal dispersed in high-molecular resin and high-molecular cholesteric liquid crystal are known as conventional rewritable thermosensible recording materials.

A leuco dye with a developer and a subtractive agent develops a color as the lactone ring contained in the leuco dye molecules opens, and loses the color as the lactone ring closes. The lactone ring opens when the material is rapidly cooled after being raised in temperature, and closes when the material is slowly cooled. Such a leuco dye is coated on a sheet member, and information is written thereon with a thermal head and erased therefrom with heat rollers.

A well-known type of organic low molecular liquid crystal dispersed in high molecular resin uses BA (behenic acid) as the organic low molecular compound and uses PVCA (polyvinylchloride polyviynlacetate copolymer) as the high molecular compound. This material can be switched between a transmitting state and a scattering state in accordance with the heating temperature and can maintain the state after being cooled. Information can be written in this material with a thermal head.

High molecular cholesteric liquid crystal polymerized with a vinyl compound having a cholesteric liquid crystal compound as a side chain is known. This material can be caused to change the display color by being heated beyond a crystallization temperature and thereafter being cooled rapidly from a predetermined temperature.

Such a leuco dye with a developer and a subtractive agent can develop only those colors determined by the leuco dye and cannot develop full colors for a desired image. The organic low molecular liquid crystal dispersed in high-molecular resin, which displays a color by switching between the transmitting state and the scattering state, cannot develop full colors either. The high molecular cholesteric liquid crystal, in which the developed color can be changed basically in accordance with the heating temperature, requires time on the order of minutes for changing the color, which poses a large stumbling block to practical applications.

Under the circumstances, a rewritable thermosensible recording medium which a full-color image can be written on and erased from at a practicable rate is yet to be successfully developed.

In the meantime, for an overhead projector (OHP) which makes a display by projecting an image, OHP sheets which are transparent plastic films are used. On an OHP sheet, an image is recorded with a writing tool such as an oil pen or with an image forming apparatus such as a copying machine, a printer or the like.

However, such OHP sheets are expensive compared with copy sheets and are difficult to reuse. Thus, conventional OHP sheets have problems in cost and resource saving. Also, because conventional OHP sheets are transparent, the background can be seen through. Therefore, the image on an OHP sheet and the background are seen overlapped, and it may be more difficult to recognize the image on an OHP sheet than to recognize the image on a sheet of paper.

### SUMMARY OF THE INVENTION

An object of the present invention is to provide an improved rewritable image bearing medium.

Another object of the present invention is to provide an image bearing medium on which full-color display is possible.

Another object of the present invention is to provide an image bearing medium on which only a short time is required to make a full-color image.

Further, another object of the present invention is to provide a rewritable image bearing medium which can be used as a document for a projector such as an OHP sheet.

In order to attain the objects above, an image bearing member according to the present invention comprises a substrate and an image bearing layer disposed on the substrate. This image bearing layer contains a low molecular compound which selectively exhibits a solid phase and a thermosensible cholesteric liquid crystal phase depending on its own temperature, and the low molecular compound changes from the thermosensible cholesteric liquid crystal phase to the solid phase keeping the state set in the thermosensible cholesteric liquid crystal phase when changing its temperature rapidly.

According to the present invention, by raising the temperature of the low molecular compound in accordance with image information, a display of a desired color can be made on the image bearing member at a high speed, and further, a full-color display can be made. Also, by heating the low molecular compound again, the information displayed on the image bearing layer can be erased.

When a transparent material is used as the substrate, the image bearing medium can be used as a document for an image projector such as an OHP sheet.

Further, the image bearing medium according to the present invention may have, between the substrate and the image bearing layer, and intermediate layer which has a smooth surface in contact with the image bearing layer. The intermediate layer may be imparted with a function of absorbing at least a component of light.

Also, the image bearing medium may be a composite of a low molecular compound and a resin material. Moreover, the image bearing layer may contain spacers to maintain the thickness of the image bearing layer.

In this specification, thermosensible cholesteric liquid crystal means a compound which has a characteristic of changing its chiral pitch as changing its temperature within a specified range. Accordingly, as thermosensible cholesteric liquid crystal changes its temperature, the wavelength of light reflected thereby changes. Further, a thermosensible cholesteric liquid crystal phase means a phase wherein thermosensible cholesteric liquid crystal exhibits the above-described characteristic.

### BRIEF DESCRIPTION OF THE DRAWINGS

These and other objects and features of the present invention will be apparent from the description below with reference to the accompanying drawings, in which:

FIG. 1 is a sectional view of a recording medium as the first embodiment of the present invention;

FIG. 2 is a sectional view of a recording medium as the second embodiment of the present invention;

FIG. 3 is a sectional view of a recording medium as the third embodiment of the present invention;

FIG. 4 is a sectional view of a recording medium as the fourth embodiment of the present invention;

FIG. 5 is a plan view of a recording medium as the fifth embodiment of the present invention;

FIG. 6 is a sectional view of the recording medium shown by FIG. 5;

FIG. 7 is a schematic view of a thermal printer;

FIG. 8 is a schematic view of a thermal head of the thermal printer;

FIG. 9 is a schematic perspective view of a laser printer;

FIGS. 10a and 10b are sectional views of a recording medium as the seventh embodiment of the present invention;

FIG. 11 is a sectional view of a recording medium as the eighth embodiment of the present invention;

FIG. 12 is a schematic view of another thermal printer;

FIG. 13 is a plan view of a thermal head of the thermal printer shown by FIG. 12;

FIG. 14 is a schematic perspective view of another laser beam;

FIGS. 15a and 15b are sectional views of a recording medium as the tenth embodiment of the present invention; and

FIG. 16 is a sectional view of a recording medium as the eleventh embodiment of the present invention.

### DETAILED DESCRIPTION OF THE PREFERRED EMBODIMENTS

Some embodiments of the present invention are described with reference to the accompanying drawings. The embodiments are described by citing specific names of materials. These materials, however, are nothing but examples, and various other materials can be used.

### First Embodiment; See FIG. 1

In FIG. 1, a rewritable thermosensible recording medium 1A comprises a base layer 2, an intermediate layer 3, a recording layer 4 and a protective layer 5. The base layer 2 is a sheet of a flexible material such as paper, polycarbonate or PET (polyethylene terephthalate). A white PET film is used in the first embodiment. The use of flexible sheets has the advantage of being capable of being bent and bound like paper.

The intermediate layer 3 contains a component having a function of absorbing visible light and the surface which is in contact with the recording layer 4 is smoother than the surface of the base layer 2. Specifically, carbon black was dispersed in silicon resin (YR3370 made by Toshiba Silicone), and this was dissolved in an isopropyl alcohol solution mixed with a catalyst (CR15 made by Toshiba Silicone). The resulting solution was coated on the base layer 2 and was thermally set by being dried to have a thickness of 5 μm.

The recording layer 4 is a liquid crystal layer containing a low molecular cholesteric liquid crystal compound. Specifically, toluene and 10, 12-dicholesteryl docosadiindionate which is a liquid crystal compound of the following chemical formula (A) were mixed and dissolved with each other at a ratio by weight of 100 to 10. This solution was coated by a blade on the intermediate layer 3 and was heated and dried to be made into a rewritable thermosensible recording layer 4 with a thickness of 10 μm. The desirable thickness of the recording layer 4 is within a range from 3 μm to 50 μm, and preferably, within a range from 6 μm to 20 μm.

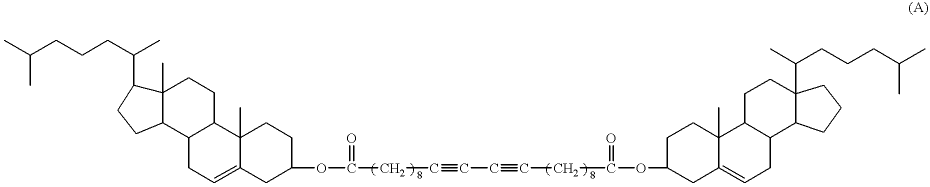

The protective layer 5 is made of a resin material. Specifically, a polyester film with a thickness of 3 μm was laid on the recording layer 4. Both were attached to each other by being heated at 100° C., and the edges were sealed with an adhesive (Alonalfar made by Toagosei Co., Ltd.).

When the recording medium 1A composed of the materials described above is heated to 87 to 115° C., the cholesteric liquid crystal compound exhibits a cholesteric phase in which the helical axis is oriented in a direction perpendicular to the intermediate layer 3, and the cholesteric liquid crystal compound reflects light of a specific wavelength depending on the temperature. The cholesteric liquid crystal compound reflects red at approximately 87° C., reflects green at approximately 95° C. and reflects blue at approximately 115° C. When rapidly cooled from these temperatures, the recording medium 1A is solidified while remaining in the reflective state.

When rapidly cooled after being heated to approximately 119° C. or higher, the recording layer 4 becomes transparent. Specifically, when the recording medium 1A is rapidly cooled after being heated to 119° C. or higher by heat rollers or the like, the recording layer 4 becomes transparent in its entirety. In this state, visible light is absorbed by the intermediate layer 3. The recording layer 4, therefore, appears black to the observer viewing from the direction indicated by arrow “A”.

When this recording medium 1A is partially heated and rapidly cooled using a conventionally-known thermal head, the heated portion develops a reflection color corresponding to the heating temperature. In FIG. 1, reference numeral 4a denotes transparent portions, and numeral 4b denotes portions remaining in the cholesteric phase. When information is written at 95° C. by a thermal head, therefore, a green display on a black background can be viewed from the direction of arrow “A”. When the writing is performed at 87° C., 95° C. and 115° C., a red display, a green display and a blue display can be viewed, and thus a full-color display is possible. According to the first embodiment, in order to make a low-reflectance display, for example, in order to make a display of dark blue partly, minuscule blue portions and minuscule black portions are arranged in mosaic in that part. Thereby, the part can be viewed as dark blue macroscopically.

In the recording medium 1A, the display color developed by the liquid crystal is observed on a black background. In the case where a coloring agent for reflecting visible light in a specific wavelength range is added to the intermediate layer 3, the display color developed by the liquid crystal is observed on a background of a single color depending on the coloring agent. For display on a white background, for example, minuscule portions of blue, green and red are arranged in mosaic in areas with no image information. Thus, white can be viewed in the areas macroscopically, thereby realizing a white background.

According to the first embodiment, the melting point of the base layer 2 is not lower than 200° C., the melting point of the intermediate layer 3 is not lower than 200° C., the crystallization temperature of the protective layer 5 is 200° C., and the melting point of the recording layer 4 is 119° C. Even when the recording layer 4 is liquefied by being heated to 119° C. or higher at the time of writing or erasing, as long as the base layer 2, the intermediate layer 3 and the protective layer 5 are kept at a temperature not higher than the melting points thereof, respectively, the mechanical strength of the layers 2, 3 and 4 can be maintained, and the thickness of the recording layer 4 can be held against the pressure exerted by the thermal head. If spherical spacers are mixed in the recording layer 4, the thickness of the recording layer 4 can be maintained more positively.

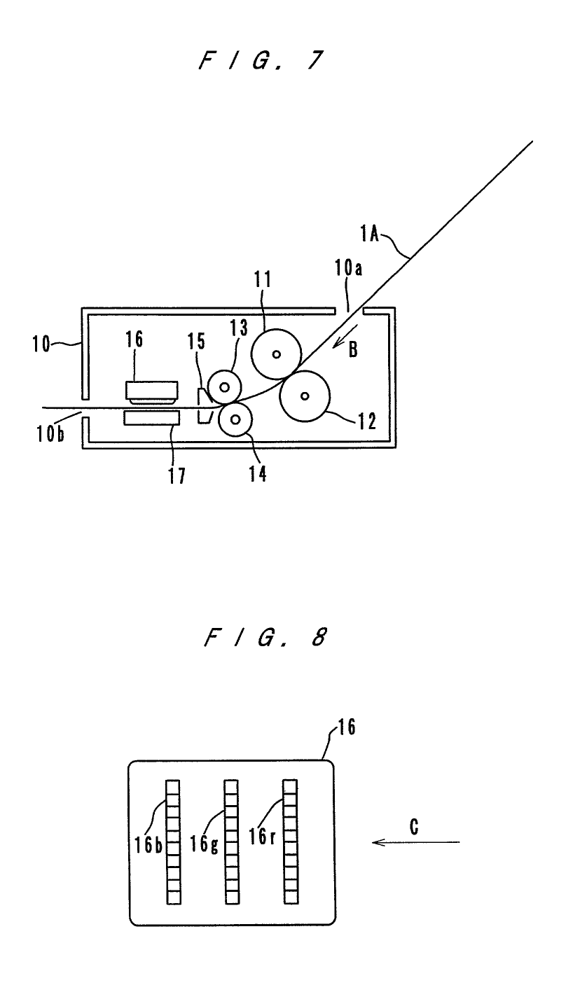

Thermal Printer; See FIGS. 7 and 8 FIG. 7 shows a thermal printer for writing information in the recording medium 1A. This printer has conveyance rollers 11 and 12, heat rollers 13 and 14, a cooler 15, a thermal head 16 and a platen 17 arranged in a housing 10 in this order along a direction “B” in which the recording medium 1A is fed.

The recording medium 1A enters the printer by way of an entrance 10a thereof, is sent from the conveyance rollers 11 and 12 between the heat rollers 13 and 14, where it is heated to 119° C. or higher. Thereafter, it is rapidly cooled by the cooler 15. In this way, the information which has been recorded in the recording medium 1A is erased. Then, the recording medium 1A is conveyed between the platen 17 and the thermal head 16 where required information is written therein. Specifically, a driver circuit (not shown) controls the heating operation of the thermal head 16 in accordance with image information inputted from an external device, and the thus controlled thermal head 16 writes information in the recording medium 1A. After the recording medium 1A is heated by the thermal head 16 into a display state, naturally, it is rapidly cooled. Then, with the written information solidified, the recording medium 1A is delivered by way of an outlet 10b.

The recording medium 1A is rapidly cooled naturally after passing by heating members of the thermal head 16. Therefore, no cooling means is required for the recording medium 1A. For more positive cooling operation, however, the cooler 15 can be provided as in the embodiment mentioned above, or another cooler can be arranged downstream of the thermal head 16.

The thermal head 16, as shown in FIG. 8, has three heating members 16r, 16g and 16b juxtaposed in a direction at a right angle to the direction recording medium traveling “B”. The heating member 16r is for writing red, the heating member 16g is for writing green, and the heating member 16b is for writing blue. Each of the heating members 16r, 16g and 16b has a multiplicity of pixel components aligned in the direction “B”. The heating members 16r, 16g and 16b are to heat the recording layer 4 of the recording medium 1A to approximately 87° C., approximately 95° C. and approximately 115° C., respectively.

The thermal head 16 is constructed to reciprocate in the direction “C” (the direction perpendicular to the page of FIG. 7) at a right angle to the recording medium traveling direction “B” in synchronism with the motion of the recording medium 1A. The heating members 16b, 16g and 16r are turned on and off in accordance with image information of the respective colors while moving in the direction “C”. By repeating the heating and non-heating, an image is written in the recording medium 1A as many lines as the pixel components arranged in a line at a time, thereby finally reproducing a full-color image on the recording medium 1A. The writing operation is performed by the heating members preferably in the descending order of temperature, i.e. by the blue heating member 16b, the green heating member 16g and the red heating member 16r in this order. It is possible to write the three colors with a single heating member; however, this requires a complicated temperature control. Therefore, it is preferred to write the three colors with different heating members.

In the first embodiment, the intermediate layer 3 with carbon black added thereto has a function of absorbing visible light in the full wavelength range. However, if the intermediate layer 3 is imparted with a function of reflecting blue light and if writing is performed so that the liquid crystal compound reflects yellow light, display in blue and white is possible. Of course, a plurality of colors can be displayed using a similar method. In this method, the reflection amount of white is the sum of the blue reflection amount of the intermediate layer 3 and the yellow reflection amount of the recording layer 4. The resulting reflection amount is greater than the reflection amount for white display with the three primary colors of blue, green and red arranged in mosaic, thus resulting in a brighter display. Also, a more colorful display becomes possible by making the intermediate layer 3 reflect a plurality of colors.

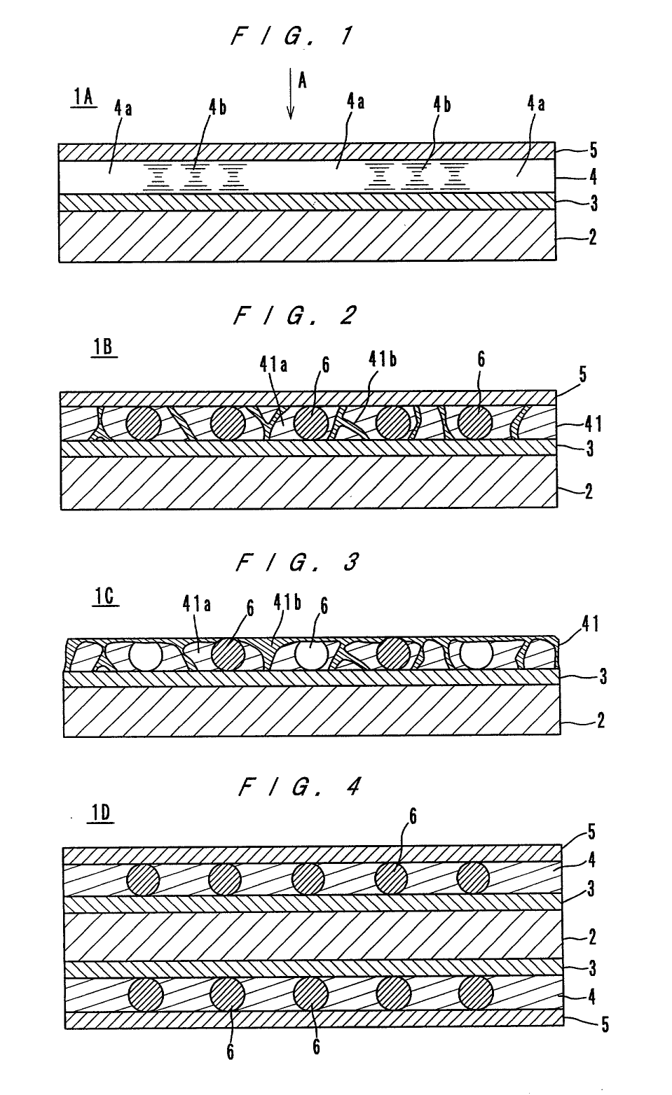

### Second Embodiment; FIG. 2

In FIG. 2, a rewritable thermosensible recording medium 1B comprises a base layer 2, an intermediate layer 3, a recording layer 41 and a protective layer 5. The layers other than the recording layer 41 are identical to the corresponding layers of the first embodiment. The recording layer 41 is a composite of a low molecular cholesteric liquid crystal compound and a high polymer resin. The low molecular liquid crystal compound is separated into liquid crystal sections 41a by the resin layer 41b. Further, spherical spacers 6 of resin or an inorganic oxide are mixed in the recording layer 41.

According to the second embodiment, in which a high-polymer composite layer is used for the recording layer 41, the mechanical strength of the recording layer 41 is so high that the damage under an external force such as friction can be minimized. Also, the recording layer 41 is not deteriorated even when the low molecular cholesteric liquid crystal compound is heated to a temperature at which it assumes an isotropic phase.

Information can be written in this rewritable thermosensible recording medium 1B with the thermal printer shown in FIGS. 7 and 8. Thus, information can be written and erased in the same manner as described above.

Now, specific examples of the materials and the method of fabrication will be explained below.

First Example of the Second Embodiment

Phthalocyanine pigment was dispersed in silicon resin (YR3370 made by Toshiba Silicone), and this was dissolved in an isopropyl alcohol solution mixed with a catalyst (CR15 made by Toshiba Silicone). The resulting solution was coated on a transparent PET (polyethylene terephthalate) film and was dried and thermally set to be made into a blue intermediate layer 3 with a thickness of 5 μm. Silica spacers 6 having an average particle size of 15 μm were dispersed in ethanol and sprayed on the intermediate layer 3.

Then, the cholesteric liquid crystal compound of the chemical formula (A) and bifunctional acrylate R712 (made by Nippon Kayaku Co., Ltd.) with an aromatic ring containing a photopolymerization initiator DAROCUR1173 (made by Chiba-Geigy (Japan)) at 3 wt % were mixed with each other at a ratio by weight of 8 to 2, and thus, a liquid crystal mixture was prepared. This liquid crystal mixture was coated on the intermediate layer 3, and a transparent polyether sulfonic film with a thickness of 2 μm was superposed thereon as a protective layer 5.

Next, while the protective layer 5 was pressed, ultraviolet rays of 0.02 mW/cm² were radiated for one hour. Thus, a composite layer (recording layer 41) with a thickness of 15 μm was formed.

Second Example of the Second Embodiment

A polyimide solution (made by Sumitomo Bakelite Co., Ltd.) was coated on a white PES (polyether sulfone) film and was dried and thermally set to be made into an intermediate layer 3 with a thickness of 1 μm. Silica spacers 6 having an average particle size of 15 μm were dispersed in ethanol and sprayed on the intermediate layer 3. Then, the liquid crystal mixture having the composition described in the first example was coated on the intermediate layer 3, and a transparent PET (polyethylene tetephthalate) film with a thickness of 2 μm was superposed thereon as a protective layer 5.

Then, while the protective layer 5 was pressed, ultraviolet rays of 15 mW/cm² were radiated for five minutes. Thus, a composite layer (recording layer 41) with a thickness of 15 μm was formed.

### Third Embodiment; See FIG. 3

In a rewritable thermosensible recording medium 1C according to the third embodiment shown in FIG. 3, the protective layer 5 of the recording medium 1B shown in FIG. 2 is omitted. Therefore, the fabrication process thereof is simplified, and the production cost can be reduced. Even in the absence of the protective layer 5, the resin layer 41b formed on the surface of the recording layer 41 functions as a protective layer. Therefore, the recording layer 41 has a sufficient mechanical strength, and damage due to an external force such as bend or friction can be minimized. Also, the low molecular cholesteric liquid crystal compound, even if heated to the temperature at which it assumes an isotropic phase, is not much deteriorated.

Specific examples of the materials and the fabrication method will be described below.

First Example of the Third Embodiment

Polyvinyl alcohol was dissolved in water at a ratio by weight of 1 to 31, and carbon black was dispersed in the resulting solution at a ratio by weight of 1 to 32. The solution thus obtained was coated on white synthetic paper to be made into an intermediate layer 3 with a thickness of 1.5 μm. Silica spacers 6 having an average particle size of 15 μm were dispersed in ethanol and sprayed on the intermediate layer 3.

Then, the liquid crystal mixture having the composition described in the second embodiment was coated on the intermediate layer 3, and ultraviolet rays of 15 mW/cm² were radiated for five minutes. Thus, a composite film (recording layer 41) with a thickness of 15 μm was formed.

Second Example of the Third Embodiment

The same intermediate layer 3 as in the first example was formed on quality paper, and further, silica spacers 6 having an average particle size of 15 μm were dispersed in ethanol and sprayed thereon. Then, the liquid crystal mixture used in the first example was coated on the intermediate layer 3. Thereafter, ultraviolet rays of 0.02 mW/cm² were radiated for one hour, and further, ultraviolet rays of 0.25 mW/cm² were radiated for another hour. Thus, a composite layer (recording layer 41) with a thickness of 20 μm was formed.

### Fourth Embodiment; See FIG. 4

A rewritable thermosensible recording medium 1D according to the fourth embodiment shown in FIG. 4 is so constructed that the intermediate layer 3, the recording layer 4 and the protective layer 5 are formed on the front and back surfaces of the base layer 2. Information can be displayed on both surfaces of this recording medium 1D.

Specifically, aluminum with a thickness of about 600 Å was provided as an intermediate layer 3 for reflecting light on both sides of a transparent PES (polyether sulfone) film with a thickness of 200 μm. The liquid crystal compound of the chemical formula (A) and toluene were mixed and dissolved with each other at a ratio by weight of 10 to 100, and silica spacers 6 having an average particle size of 15 μm were mixed in this solution. The resulting solution was coated by a blade on the intermediate layer 3 and was heated and dried to be made into a rewritable thermosensible recording layer 4 with a thickness of 20 μm. Further, a polyester film with a thickness of 5 μm was laid on the recording layer 4 and attached thereto by being heated at 100° C.

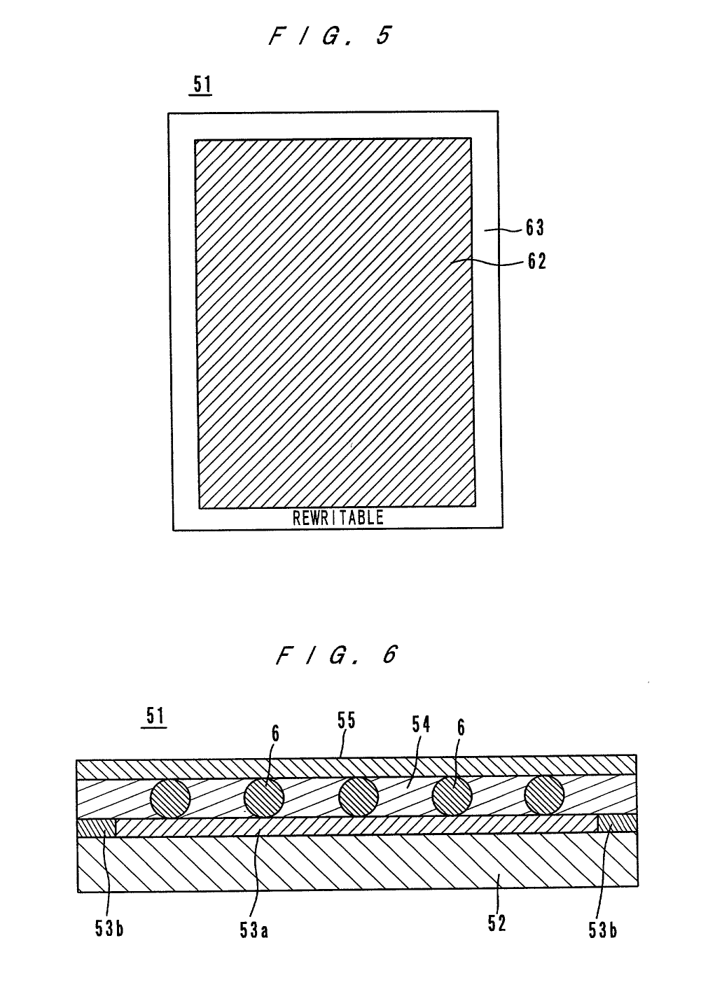

### Fifth Embodiment; See FIGS. 5 and 6

A rewritable thermal recording medium 51 according to the fifth embodiment shown in FIG. 5 has a central light absorbing area 62 shown as a shadowed portion and a light scattering area 63 along the periphery thereof. According to the first to fourth embodiments described above, the intermediate layer 3 with a light absorbing function is formed over the entire surface of each of the recording media 1A through 1D. In the fifth embodiment, the light scattering area 63 is arranged along the periphery. Each of the recording media 1A through 1D described in the first to fourth embodiments is initialized to a black display in its entirety by being heated through heat rollers. In the presence of a marginal area of the printer where writing is impossible, however, the peripheral portion is left black after an image is written in the recording medium. Accordingly, in the case of making a display on a colored background or on a white background, the display becomes unnatural as compared with an image written on paper in a method of prior art. In the recording medium 51 according to the fifth embodiment, the area corresponding to the margin of the printer constitutes the light scattering area 63, whereby a natural display with a white peripheral portion becomes possible. Each side of the light scattering area 63 as the margin is several millimeters to two centimeters wide, and preferably, one centimeter to two centimeters.

FIG. 6 is a sectional view of the recording medium 51 comprising a base layer 52, intermediate layers 53a and 53b, a recording layer 54 having spacers 6, and a protective layer 55. The intermediate layer 53a is formed in a portion corresponding to the light absorbing area 62 and has a light-absorbing function. The intermediate layer 53b, on the other hand, is formed in a portion corresponding to the light scattering area 63 and is made of a light-transmitting material. When paper is used as the base layer 52, use of a transparent material as the intermediate layer 53b imparts a light scattering characteristic to the peripheral portion. In the case where a transparent material is used as the base layer 52, on the other hand, it is possible to impart a light scattering characteristic to the peripheral portion by dispersing titanium oxide particles or the like in the area of the intermediate layer 53b.

In FIG. 5, the character “REWRITABLE” under the recording medium 51 is preprinted in the light scattering area 63 and indicates that this recording medium 51 is a rewritable thermosensible recording medium. Of course, the name of a company or a decoration pattern can be printed as well as the character.

A specific example of the materials and the fabrication method will be described below.

An isopropyl alcohol solution with carbon black dispersed in a copolymer nylon resin (CM8000 made by Toray Industries, Inc.) was coated as the intermediate layer 53a on quality paper and dried to have a thickness of 5 μm. Also, an isopropyl alcohol solution with titanium oxide dispersed in the same copolymer nylon resin was coated on the quality paper as the intermediate layer 53b and dried to have a thickness of 5 μm.

Then, the liquid crystal compound of the chemical formula (A) and toluene were mixed and dissolved with each other at a ratio by weight of 10 to 100, and silica spacers 6 having an average particle size of 15 μm were mixed in this solution. The resulting solution was coated by a blade on the intermediate layer 53a and was heated and dried to be made into a rewritable thermosensible recording layer 54 with a thickness of 20 μm. Further, an ultraviolet-setting resin (Unidic C7-157 made by Dainippon Ink & Chemicals, Inc.) containing urethane acrylate as the main component was diluted by ethyl acetate at a ratio by weight of 100 to 50, and the resulting solution was coated on the recording layer 54. Then, ultraviolet rays of 15 mW/cm² were radiated for five minutes. Thus, a protective layer 55 with a thickness of 4 μm was formed.

### Sixth Embodiment

According to the sixth embodiment, though not specifically shown, an infrared absorbent is dispersed in the intermediate layers 3 and 53a and/or the protective layers 5 and 55 of the first to fifth embodiments to provide a function of converting infrared light into heat. As an alternative, the intermediate layers 3 and 53a and/or the protective layers 5 and 55 themselves can be formed of a material capable of absorbing infrared light. Imparting a function of absorbing infrared light to the neighborhood of the recording layers 4 and 54 in this way enables a laser printer to write information therein efficiently.

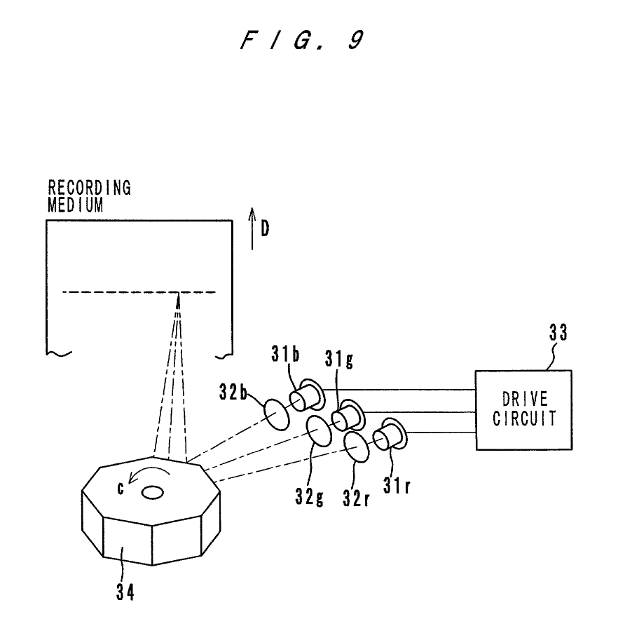

### Laser printer; See FIG. 9

The configuration of a laser printer for writing information in the recording medium according to the sixth embodiment is schematically shown in FIG. 9. This printer has laser diodes 31b, 31g and 31r for writing blue, green and red, respectively. These laser diodes 31b, 31g and 31r are modulated by a drive circuit 33, and laser beams emitted from the laser diodes 31b, 31g and 31r are incident to a polygon mirror 34 through collimator lenses 32b, 32g and 32r. The polygon mirror 34 is rotated in the direction of arrow “c”. With the rotation, the laser beams are deflected to scan the recording medium linearly, while the recording medium is conveyed along the direction of arrow “D”. Thus, two-dimensional full-color information is written in the recording medium.

Though not shown, the laser printer also has such an optical element as an fθ lens.

The color to be written is determined by controlling the radiation energy of the laser diodes 31b, 31g and 31r. It is also possible to write the colors with a single laser diode by controlling the energy of the laser beam for the respective colors. The energy control, however, is easier when three laser diodes are used to write information in the three colors separately.

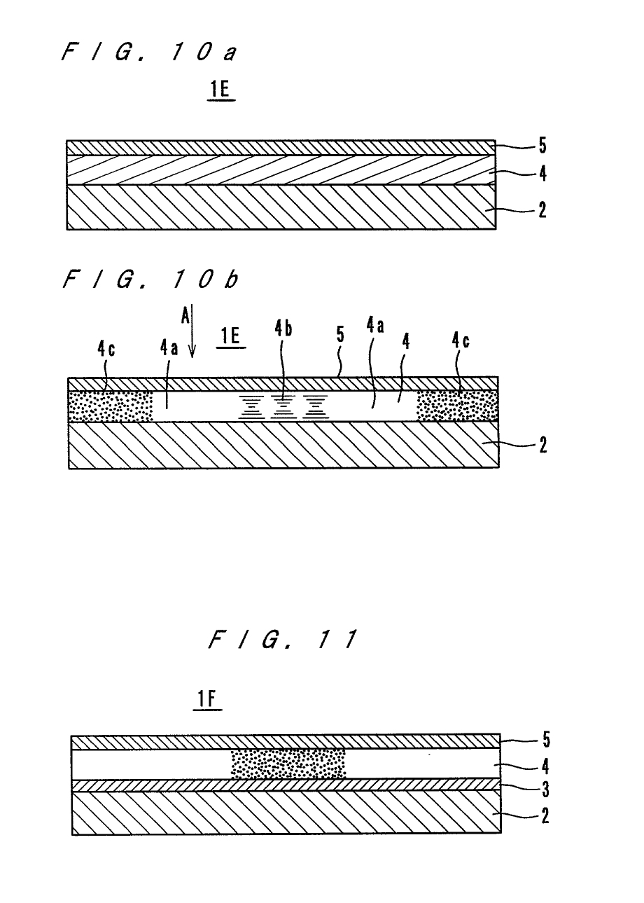

### Seventh Embodiment; See FIGS. 10a and 10b

As FIGS. 10a and 10b show, a rewritable thermosensible recording medium 1E according to the seventh embodiment comprises a base layer 2, a recording medium 4 and a protective layer 5. The base layer 2 is a transparent plastic film. The recording layer 4 contains an organic low molecular cholesteric liquid crystal compound. This liquid crystal compound, when it is heated from a room temperature to a high temperature and thereafter cooled rapidly, transmits visible light at least within a certain wavelength range. Specifically, when the liquid crystal compound is heated to a temperature over the phase transition temperature and thereafter cooled rapidly, it becomes transparent. When it is heated to a temperature over the room temperature and under the phase transition temperature, it reflects visible light within a wavelength range, which depends on the heated temperature, and transmits visible light out of the wavelength range. Then, when the liquid crystal compound is cooled rapidly from the temperature, it is solidified with the reflection state maintained. Also, when the liquid crystal compound is heated over the room temperature and thereafter cooled slowly, it scatters light. Out of such low molecular cholesteric liquid crystal compounds, 10, 12-dicholesteril docosadiindionate of the chemical formula (A) is the most suited to be used for such a rewritable thermosensible recording layer 4. The thickness of the recording layer 4 is desirably within a range from 3 82 m to 50 μm, and preferably within a range from 6 μm to 20 μm.

Because this recording medium 1E has the recording layer 4 containing the liquid crystal compound of the chemical formula (A), when it is heated to a temperature within a range from 87° C. to 115° C., it exhibits a cholesteric phase wherein the herical axis of the cholesteric liquid crystal compound is oriented in a direction perpendicular to the base layer 2 and reflects light with a specified wavelength according to the temperature. Specifically, when the recording medium 1E is heated to approximately 87° C., the recording layer 4 shows red; when heated to approximately 95° C., the recording layer 4 shows green; when heated to approximately 115° C., the recording layer 4 shows blue; and when heated to approximately 120° C., the recording layer 4 becomes transparent. Then, when the recording medium 1E is cooled from these temperatures rapidly, the recording layer 4 is solidified with the respective reflection states maintained.

Also, when the recording medium 1E is heated over a liquid crystal phase temperature (which means a temperature at which the recording layer 4 starts exhibiting a liquid crystal phase) and thereafter cooled slowly, the recording layer 4 comes to a scattering state and becomes translucent. Specifically, when the recording layer 4 is heated to 85° C. or higher by use of heat rollers or the like and thereafter cooled slowly, the entire surface of the recording layer 4 comes to a scattering state. If the recording medium 1E is used as an OHP film, when light coming from the direction of arrow “A” is projected, the recording layer 4 in this scattering state is seen as a dark color. In order to erase an image which has been recorded in the previous writing operation, it is preferred to heat the recording layer 4 over the phase transition temperature at which the recording layer 4 comes to an isotropic phase and thereafter cool the recording layer 4 slowly.

When the recording medium 1E is partly heated by use of a thermal head which generates heat in accordance with image information and thereafter cooled rapidly, the heated part shows a reflected color which depends on the temperature. In FIG. 10b, the reference symbol 4a denotes the heated reflection part. For example, writing by use of a thermal head is performed at a temperature of 95° C. so that the recording layer 4 will reflect light of green, and light coming from the direction of arrow “A” is projected on the recording medium 1E which is used as an OHP film. In this case, a display of light red which is a complementary color of green can be observed on a dark background.

The reference symbol 4b denotes a part which becomes transparent by being heated to a temperature to 119° C. or higher and thereafter cooled rapidly. Viewing from the side of “A”, this part 4b is seen as a bright color. The part denoted by the reference symbol 4c is a scattering part which was cooled slowly after being heated, and this part is a marginal part wherein writing by use of a thermal head is not performed. Also, when writing is performed at 87° C., 95° C., 115° C. and not lower than 119° C., displays of the respective colors can be obtained.

In the seventh embodiment, both the melting point of the base layer 2 and that of the protective layer 5 are not lower than 200° C., and the phase transition temperature at which the liquid crystal compound contained in the recording layer 4 changes from a liquid crystal phase to an isotropic phase is 119° C. Therefore, even if the recording layer 4 is liquefied by being heated to 119° C. or higher in writing or erasing operation, as long as the base layer 2 and the protective layer 5 are kept in a temperature under their melting points, the mechanical strength of the layers 2 and 5 can be maintained, and the thickness of the recording layer 4 can be maintained even with pressure applied from the thermal head. Further, by mixing spherical spacers in the recording layer 4, the thickness of the layer 4 can be maintained more positively. Also, in the eighth embodiment described below, the melting point of an intermediate layer 3 is not lower than 200° C.

Now, specific examples of the composition and the fabrication method of the rewritable thermosensible recording medium are shown. First Example of the Seventh Embodiment The liquid crystal compound of the chemical formula (A) was mixed and dissolved with dichloroethane at a ratio by weight of 10 to 100. This solution was coated by a blade on a transparent polyester film with a thickness of 100 μm and was heated and dried to be made into a rewritable thermosensible recording layer 4 with a thickness of 10 μm. Further, a polyester film with a thickness of 5 μm was laid on the recording layer 4 and joined thereto by being heated to 100° C. Then, this was cooled slowly, whereby the recording layer 4 came to a translucent scattering state.

In this example, a part where writing by use of a thermal head was performed at 98° C. became green. In other words, a green display was seen on a white background. When this was projected by use of an overhead projector, the translucent scattering portion was seen as a dark color, and the green display became light red. Accordingly, a light red image with a good contrast to a dark background could be obtained. Also, when writing at 119° C. was performed in a part of the recording medium, the part was seen as another color different from the color of the part where writing at 98° C. was performed. When the recording medium was heated to 120° C. by heat rollers and thereafter cooled slowly, the entire surface of the recording layer 4 came to a translucent scattering state.

Second Example of the Seventh Embodiment

Dichloroethane, the liquid crystal compound of the chemical formula (A) and silica spacers with a diameter of 10 μm were mixed and dissolved with each other at a ratio by weight of 100:10:0.1. This solution was coated by a blade on a transparent polyester film with a thickness of 100 μm and was heated and dried to be made into a recording layer 4 with a thickness of 10 μm. Further, a polyester film with a thickness of 5 μm was laid on the recording layer 4 and joined thereto by being heated to 100° C. Then, this was cooled slowly, whereby the recording layer 4 came to a translucent scattering state.

In the second example, a part where writing by use of a thermal head was performed at 120° C. became transparent. Accordingly, when this recording medium was laid on a surface of a specified color, a display of the color was seen on a white background. For example, when the recording medium was laid on a black surface, a black display was seen on a white background. When this was projected by use of an overhead projector, the translucent scattering part became dark color, and a bright image with a good contrast to a dark background could be obtained. On the other hand, when writing was performed at 120° C. in an area with no image information (in a background) on the recording medium, the written area became transparent, and the other portions (corresponding to portions with image information) were kept in the translucent scattering state. Thereby, a white image on a transparent background could be obtained. When this was projected by use of an overhead projector, the translucent scattering part became dark color, and an image of a dark color with a good contrast to the background of the color of the light source could be obtained. After the image writing described above, when the recording medium 1E passed between heat rollers which were heated to 120° C. and thereafter was cooled slowly, the entire surface of the recording medium 1E came to a translucent scattering state.

Third Example of the Third Embodiment

The cholesteric liquid crystal compound of the chemical formula (A) and bifunctional acrylate R712 (made by Nippon Kayaku Co., Ltd.) with an aromatic ring containing a photopolymeraization initiator DAROCUR1173 (made by Chiba-Geigy (Japan)) at 3 wt % were mixed with each other at a ratio by weight of 8 to 2. Thereby, a liquid crystal mixture was prepared, and this liquid crystal mixture was coated on a yellow polyimide film. Ultraviolet rays of 0.02 mW/cm² were radiated for one hour, and further ultraviolet rays of 0.25 mW/cm² were radiated for another hour. In this way, a composite layer (rewritable thermosensible recording layer 4) with a thickness of 15 μm was formed.

In the third example, a part of the recording layer 4 where writing by use of a thermal head was performed at 120° C. became transparent, and because of the base layer 2, the part was seen as yellow. The other parts were left in a translucent scattering state. Thus, a yellow display was seen on a white background. When this was projected by use of an overhead projector, the translucent scattering part became a dark color, and a yellow image with a good contrast to the background of the dark color could be obtained. On the other hand, when writing was performed at 120° C. in an area with no image information (background), the written area became transparent, and the other parts (parts with image information) were left in a translucent scattering state. Thus, a white image could be obtained on a transparent background. When this was projected by use of an overhead projector, the translucent scattering part became a dark color, and an image of the color of the light source with a good contrast to the dark background could be obtained. After the image writing described above, when the recording medium passed between heat rollers which were heated to 120° C. and thereafter was cooled slowly, the entire surface of the recording layer 4 came to a translucent scattering state.

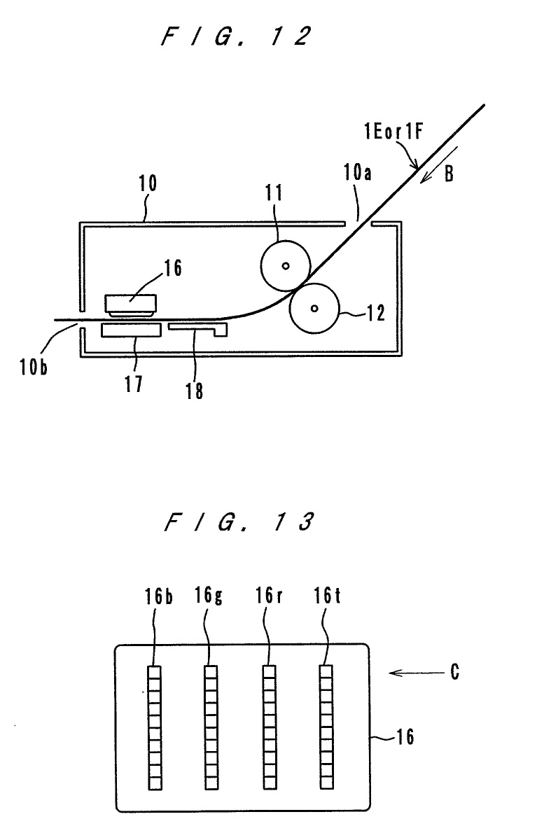

### Eighth Embodiment; See FIG. 11

As FIG. 11 shows, a rewritable thermosensible reacording medium 1F comprises a base layer 2, an intermediate layer 3, a recording layer 4 and a protective layer 5. The intermediate layer 3 contains a component which absorbs visible light in a specified wavelength range. Writing and easing of information on and from the recording layer 4 are the same as in the seventh embodiment.

Specific examples of the materials and the fabrication method of the rewritable thermosensible recording medium of the eighth embodiment are given below.

First Example of the Eighth Embodiment

Phthalocyanine pigment, which serves as a light absorbent, was mixed with silicone resin (YR3370 made by Toshiba Silicone), and further, this was dissolved in an isopropyl alcohol solution mixed with a catalyst (CR15 made by Toshiba Silicone). This solution was coated on a polyether sulfone film and was dried and set to be made into a blue intermediate layer 3 with a thickness of 5 μm. Silica spacers with an average particle size of 15 μm were dispersed in ethanol and sprayed on the intermediate layer 3.

The cholesteric liquid crystal compound of the chemical formula (A) and bifunctional acrylate R712 (made by Nippon Kayaku Co., Ltd.) with an aromatic ring containing a photopolymerization initiator DAROCUR1173 (made by Chiba-Geigy (Japan)) at 3 wt % were mixed with each other at a ratio by weight of 8 to 2. Thereby, a liquid crystal mixture was prepared. This liquid crystal mixture was coated on the intermediate layer 3, and further, a transparent film with a thickness of 2 μm was laid thereon as a protective layer 5.

Next, while the protective layer 5 was pressed, ultraviolet rays of 0.02 mW/cm² were radiated for one hour, and further ultraviolet rays of 0.25 mW/cm² were radiated for another hour. In this way, a rewritable thermosensible recording layer 4 with a thickness of 15 μm was formed.

In this first example, a part of the recording layer 4 where writing by use of a thermal head was performed at 120° C. became transparent, and because of the base layer 2, this part became blue. The other parts were left in a translucent scattering state. Thus, a blue display was seen on a white background. When this was projected by use of an overhead projector, the part in a translucent scattering state was seen as a dark color, and a blue image with a good contrast to the dark background could be obtained. When the recording medium was cooled slowly after passing between heat rollers which were heated to 120° C., the entire surface of the recording layer 4 came to a translucent scattering state.

Second Example of the Eighth Embodiment

On a transparent polyether sulfone film with a thickness of 100 μm, an orientation film of polyimide with a thickness of 1 μm was coated as the intermediate layer 3. Next, the liquid crystal compound of the chemical formula (A) and toluene were mixed and dissolved with each other at a ratio by weight of 10 to 100, and this solution was coated by a blade on the intermediate layer 3 and was heated and dried to be made into a rewritable thermosensible recording layer 4 with a thickness of 12 μm. Further, a polyester film with a thickness of 5 μm was laid on the recording layer 4 and was joined thereto by being heated to 100° C. Thereafter, when this was cooled slowly, the recording layer 4 came to a translucent scattering state.

In the second example, a part of the recording layer 4 where writing by use of a thermal head was performed at 120° C. became transparent. Accordingly, when this recording medium 1F was mounted on a surface of a specified color (for example, on a black surface), a display of the color (a black display in the case of black surface) was seen on a white background. When this was projected by use of an overhead projector, the part in a translucent scattering state was seen as a dark color, and an image with a good contrast to the dark background could be obtained. Thereafter, when this recording medium passed between heat rollers which were heated to 120° C. and thereafter was cooled slowly, the entire surface of the recording layer 4 came to a translucent scattering state.

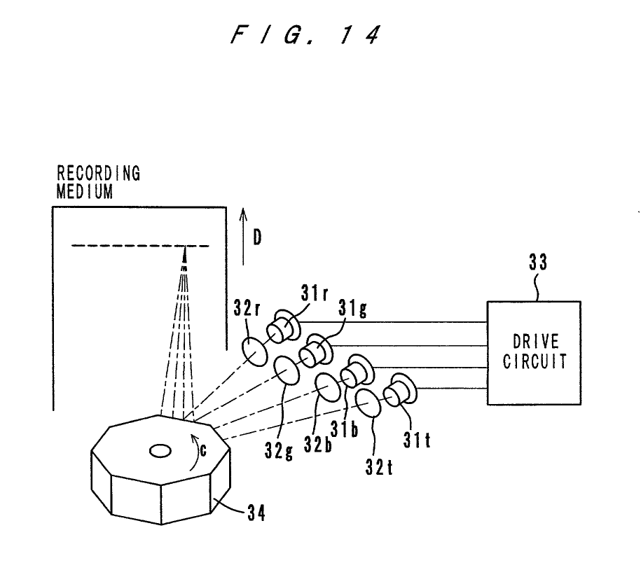

### Thermal Printer; See FIGS. 12 and 13

FIG. 12 shows a thermal printer for writing information in the recording media 1E and IF. This printer is basically of the same structure as the printer shown by FIG. 7. In an housing 10, conveyance rollers 11 and 12, a heating/cooling plate 18, a thermal head 16 and a platen 17 are provided in the recording medium traveling direction “B” in this order. The heating/cooling plate 18 is to heat and slowly cool the recording medium 1E or 1F. The plate 18 has a heater in a part near the conveyance rollers 11 and 12, and as the recording medium 1E or 1F is traveling farther from the rollers 11 and 12, it is slowly cooled.

The recording medium 1E or 1F enters the printer through an entrance 10a and is conveyed to the heating/cooling plate 18 through the conveyance rollers 11 and 12. First, the recording medium 1E or 1F is heated to an erasing temperature not lower than 119° C. and thereafter is cooled slowly. Thereby, information which has been recorded on the medium is erased. Next, the recording medium 1E or 1F is conveyed between the platen and the thermal head 16, where necessary information is written thereon. The recording medium 1E or 1F is heated by the thermal head 16 to have a display thereon and thereafter naturally is cooled rapidly. Thereby, the display is fixed thereon, and the recording medium 1E or 1F is ejected from the printer through an exit 10b.

Since the recording medium 1E or 1F is naturally cooled rapidly after passing by heating members of the thermal head 16, a cooling device is basically unnecessary. For more positive cooling operation, however, a cooler can be provided in a position downstream of the thermal head 16.

It is desired that the width of the heating/cooling plate 18 is larger than the width of the writing range wherein the thermal head 16 writes information. With this arrangement, even if the recording medium 1E or 1F is conveyed slightly displaced in the width direction, the information written in the recording medium can be erased certainly. Further, in order to perform erasing uniformly on the entire surface of the recording medium 1E or 1F, preferably, the width of the heating/cooling plate 18 is larger than the width of the recording medium 1E or 1F.

As FIG. 13 shows, the thermal head 16 has four heating members 16t, 16r, 16g and 16b which are juxtaposed in a direction perpendicular to the recording medium traveling direction “B”. The heating member 16t is to write a transparent image; the heating member 16r is to write a red image; the heating member 16g is to write a green image; and the heating member 16b is to write a blue image. Each of the heating members 16t, 16r, 16g and 16b has a multiplicity of pixel components which are aligned in the recording medium traveling direction “B”. The heating members 16t, 16r, 16g and 16b are to heat the recording layer 4 to approximately 120° C., approximately 87° C., approximately 95° C. and approximately 115° C., respectively.

The thermal head 16 is so constituted to reciprocate in the direction “C” perpendicular to the recording medium traveling direction “B” in synchronization with the movement of the recording medium 1E or 1F. The heating members 16t, 16r, 16g and 16b are turned on and off in accordance with image information of the respective colors while moving in the direction “C”. The thermal head 16 writes as many lines as the number of pixel components arranged in each line at a time, and by repeating the heating process and the non-heating process, the thermal head 16 reproduces a full-color image on the recording medium 1E or 1F. The writing is preferably performed in order of necessary temperature. Specifically, it is preferred that the transparent heating member 16t, the blue heating member 16b, the green heating member 16g and the red heating member 16r perform writing in this order. Further, it is possible to write in transparent and the three colors with a single heating member; however, it requires a complicated temperature control, and it is preferred that writing is performed with four heating members.

When a color display on a white background is desired or when a color display is to be made by writing with the transparent heating member 16t to make the color of the base layer appear, the recording medium 1E or 1F is reset to a translucent scattering state, and writing is performed in portions with image information on the recording medium 1E or 1F with the heating member of that color or the transparent heating member (character writing). On the other hand, a white display on a transparent background is desired, the recording medium 1E or 1F is reset to a translucent scattering state, and writing is performed in portions with no image information on the recording medium 1E or 1F with one of the color heating members or the transparent heating member (background writing).

In color writing, when writing is performed with mutually different reflection wavelengths selected in a plurality of portions, characters of a plurality of colors can be written.

### Ninth Embodiment

It is possible to impart a function of absorbing infrared rays to the intermediate layer 3 and/or the protective layer 5 of the eighth embodiment shown by FIG. 11 by dispersing a near infrared light absorbent in the layer 3 and/or the layer 5 or by making the layer 3 and/or the layer 5 of a near infrared light absorbing material. In the ninth embodiment, though not shown, a part near the recording layer 4 has an infrared light absorbing function. Thereby, effective writing on the recording medium of the ninth embodiment by use of a laser printer becomes possible.

### Laser Printer; See FIG. 14

FIG. 14 is a schematic view of a laser printer for writing information on the recording medium of the ninth embodiment. This printer is basically of the same structure as the printer shown by FIG. 9. Laser diodes 31t, 31b, 31g and 31r for writing of a transparent image, a blue image, a green image and a red image, respectively, are modulated by a driving circuit 33. Laser beams emitted from the laser diodes 31t, 31b, 31g and 31r are incident to a polygon mirror 34 through collimator lenses 32t, 32b, 32g and 32r, respectively. The polygon mirror 34 are driven to rotate in the direction of arrow “c”, and with this rotation, the laser beams are deflected and scanned linearly on the recording medium 1. Meanwhile, the recording medium is conveyed in the direction of arrow “B”, and thus, image information is written thereon two-dimensionally.

Although they are not shown, optical elements such as an fθ lens are provided in the laser printer.

Color selection is realized by controlling radiation energy of the laser diodes 31t, 31b, 31g and 31r. Therefore, it is possible to write a full-color image with a single laser diode by controlling the energy of the laser beam for the respective colors. However, when four laser diodes are used to write the colors separately, energy control is easier.

Such an optical writing method as the above-described laser beam method has the advantage that a clearer image can be obtained in a case of background writing.

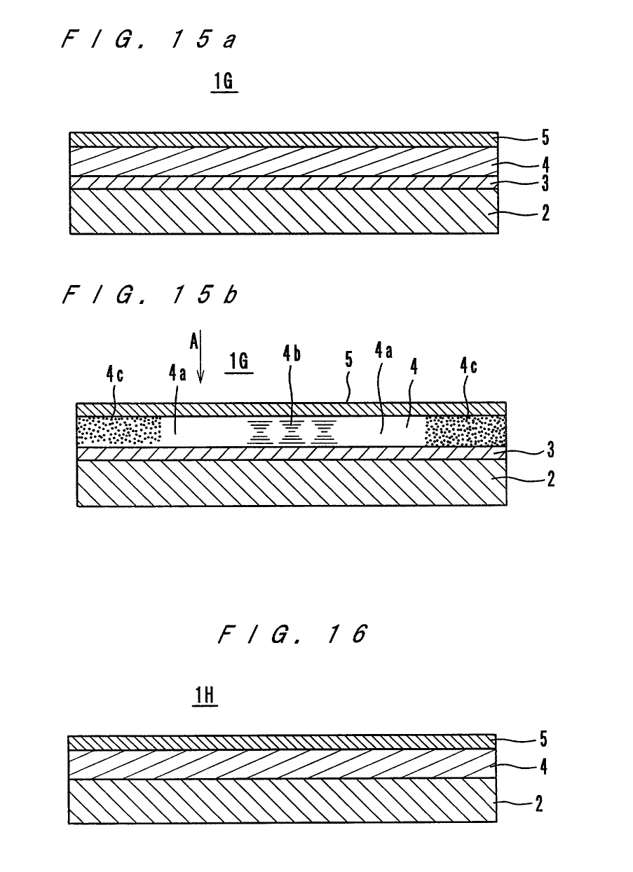

### Tenth Embodiment; See FIGS. 15a and 15b

As FIGS. 15a and 15b show, a rewritable thermosensible recording medium 1G comprises a base layer 2, an intermediate layer 3, a recording layer 4 and a protective layer 5. The base layer 2 is a sheet of a flexible material such as paper, polycarbonate, PET (polyethylene terephthalate) or the like. The use of flexible sheets has the advantage of being handled like paper, and specifically, of being bent and bound. The intermediate layer 3 contains a component which has a function of absorbing visible light, and the surface which is in contact with the recording layer 4 is smoother than the surface of the base layer 2.

If the intermediate layer 3 is colored and translucent, the base layer 2 preferably has a characteristic of absorbing light or absorbs light in cooperation with the intermediate layer 3 so that a quality full-color image can be reproduced. It is possible to make the intermediate layer 3 of a transparent material. In this case, it is preferred that the base layer 2 has a function of absorbing light.

The recording layer 4 contains an organic low molecular cholesteric liquid crystal compound. This liquid crystal compound, when it is under a temperature higher than the room temperature, is in a cholesteric phase and reflects light within a certain wavelength range depending on the temperature. Then, when the liquid crystal compound is cooled from the temperature rapidly, it is solidified with the reflection state maintained. Moreover, the liquid crystal compound comes to an isotropic phase when it is heated higher, and when it is cooled slowly from the temperature where it is in a cholesteric phase or the temperature wherein it is in an isotropic phase, it comes to a scattering state. Out of such low molecular cholesteric liquid crystal compounds, 10, 12-dicholesteril docosadiindionate of the chemical formula (A) is the most suited to be used for the recording layer 4. The thickness of the recording layer 4 is desirably within a range from 3 μm to 5 μm, and preferably within a range from 6 μm to 20 μm.

Since the recording layer 4 of the recording medium 1G contains the liquid crystal compound of the chemical formula (A), when the recording medium 1G is heated to a temperature within a range from 87° C. to 115° C., the recording layer 4 comes to a cholesteric phase wherein the herical axis is oriented in a direction perpendicular to the base layer 2 and reflects light of a specified wavelength depending on the temperature. When it is heated to approximately 87° C., the recording layer 4 is seen as red; when heated to approximately 95° C., the recording layer 4 is seen as green; and when heated to approximately 115° C., the recording layer 4 is seen as blue. Then, when the recording medium 1G is cooled rapidly from these temperatures, the recording layer 4 is solidified with the respective reflection states maintained.

Also, when the recording medium 1G is heated to 119° C. or higher, the recording layer 4 comes to an isotropic phase. Thereafter, when the recording medium 1G is cooled rapidly, the recording layer 4 becomes transparent, and when the recording medium 1G is cooled slowly, the recording layer 4 becomes translucent and comes to a scattering state. Specifically, when the recording medium 1G is heated to 119° C. or higher by use of heat rollers and thereafter cooled slowly, the entire surface of the recording layer 4 comes to a scattering state. The recording layer 4 in this state is seen as white to an observer viewing from the direction “A”.

When the recording medium 1G is partly heated and cooled rapidly with a thermal head which generates heat in accordance with image information, the heated part shows a color depending on the temperature. In FIG. 15b, the reference symbol 4a denotes a heated reflection part. When writing by use of a thermal head is performed at 95° C., a green display on a white background can be viewed from the direction “A”. The thermal printer shown by FIG. 12 can be used.

The part denoted by the reference symbol 4b in FIG. 15b is a transparent part which was heated to 119° C. or higher and thereafter cooled rapidly. This part is seen to be the color of the intermediate layer 3, that is, black from the direction “A”. Therefore, when writing is performed at 119° C. or higher, a black display on a white background can be obtained. The part denoted by the reference symbol 4c is a scattering part which was heated by heat rollers and thereafter cooled slowly, and this part is a margin where the thermal head does not perform writing. Moreover, when writing is performed at 87° C., 95° C., 115° C. and a temperature not lower than 119° C., a red display, a green display, a blue display and a black display can be viewed, and thus, a full-color display is possible. In the tenth embodiment, in order to make a low-reflectance display, for example, in order to make a display of dark blue partly, minuscule blue portions and minuscule black portions are arranged in mosaic in that part. Thereby, the part can be viewed as dark blue macroscopically.

In the tenth embodiment, the melting point of the base layer 2 is not lower than 200° C.; the melting point of the intermediate layer is not lower than 200° C.; and the melting point of the protective layer 5 is not lower than 200° C. The phase transit temperature of the recording layer 4 at which the liquid crystal compound contained therein changes from the liquid crystal phase to the isotropic phase is 119° C. Therefore, during writing or erasing operation, even if the recording layer 4 is heated to 119° C. or higher and is liquefied, as long as the temperature is kept lower than the melting points of the base layer 2, the intermediate layer 3 and the protective layer 5, the mechanical strength of the layers 2, 3 and 5 can be maintained, and the thickness of the recording layer 4 can be maintained against the pressure applied from the thermal head. In order to maintain the thickness more positively, spherical spacers are mixed in the recording layer 4.

Specific examples of the materials and the fabrication method of the rewritable thermosensible recording medium 1G according to the tenth embodiment are described below.

First Example of the Tenth Embodiment

Carbon black, which serves as a light absorbent, was dispersed in silicone resin (YR3370 made by Toshiba Silicone), and this was dissolved in an isopropyl alcohol solution mixed with a catalyst (CR15 made by Toshiba Silicone). This solution was coated on a sheet of composite paper and was dried and set to have a thickness of 5 μm. Thus, a black intermediate layer 3 with a light absorbing function was formed.

Next, toluene and the liquid crystal compound of the chemical formula (A) were mixed and dissolved with each other at a ratio by weight of 100 to 10. This solution was coated by a blade on the intermediate layer 3 and was heated and dried to be made into a rewritable thermosensible recording layer 4 with a thickness of 10 μm. Further, a polyester film with a thickness of 3 μm was laid on the recording layer 4 and was joined thereto by being heated to 100° C. Then, the sides were sealed with an adhesive (Alonalfar made by Toa Gosei Co., Ltd.). Thus, a protective layer 5 was formed.

In the first example, a part of the recording layer 4 where writing by use of a thermal head was performed at 120° C. became transparent, and accordingly, a black image with a good contrast to a white background could be obtained. Also, when writing by use of a thermal head at 87° C., 95° C. and 115° C., a red image, a green image and a blue image with a good contrast to a white background could be obtained, respectively. When the recording medium 1G passed between heat rollers which were heated to 120° C. and thereafter cooled slowly, the entire surface of the recording layer 4 comes to a translucent scattering state.

Second Example of the Tenth Embodiment

Phthalocyanine pigment, which serves as a light absorbent, was dispersed in silicone resin (YR3370 made by Toshiba Silicone), and this was dissolved in an isopropyl alcohol solution mixed with a catalyst (CR15 made by Toshiba Silicone). This solution was coated on a sheet of quality paper and was dried and set to be made into a blue intermediate layer 3 with a thickness of 5 μm. Silica spacers with an average particle diameter of 15 μm were dispersed in ethanol and sprayed on the intermediate layer 3.

Next, the cholesteric liquid crystal compound of the chemical formula (A) and bifunctional acrylate R712 (made by Nippon Kayaku Co., Ltd.) with an aromatic ring containing a photopolymerization initiator DAROCUR1173 (made by Chiba-Geigy (Japan)) at 3 wt % were mixed with each other at a ratio by weight of 8 to 2. Thus, a liquid crystal mixture was prepared. This liquid crystal mixture was coated on the intermediate layer 3, and a transparent polyether sulfone film with a thickness of 2 μm was laid on the liquid crystal mixture as a protective layer 5.

Then, while the protective layer 5 was pressed, ultraviolet rays of 0.02 mW/cm² were radiated for one hour, and further, ultraviolet rays of 0.25 mW/cm² were radiated for another hour. Thus, a color rewritable thermosensible recording layer 4 with a thickness of 15 μm was formed.

In the second example, a part of the recording layer 4 where writing by use of a thermal head was performed at 120° C. became transparent. The other parts which keep in a translucent scattering state became white, and a blue image with a good contrast to a white background could be obtained. Also, when the recording medium 1G passed between heat rollers which were heated to 120° C. and thereafter was cooled slowly, the entire surface of the recording layer 4 came to a translucent scattering state.

Third Example of the Tenth Embodiment

Carbon black, which serves as a light absorbent, was dispersed in copolymer nylon (CM8000 made by Toray Industries, Inc.), and this was dissolved in an isopropyl alcohol solution. This solution was coated on a sheet of composite paper and was dried to be made into an intermediate layer 3 with a thickness of 5 μm. Next, the liquid crystal compound of the chemical formula (A) mixed with silica spacers with an average particle diameter of 15 μm and bifunctional acrylate R712 (made by Nippon Kayaku Co., Ltd.) with an aromatic ring containing a photopolymerization initiator DAROCUR1173 (made by Chiba-Geigy (Japan)) at 3 wt % were mixed with each other at a ratio by weight of 8 to 2. Thus, a liquid crystal mixture was prepared. This liquid crystal mixture was coated on the intermediate layer 3, and a transparent PET (polyethilene telephthalate) film with a thickness of 2 μm was laid on the liquid crystal mixture as a protective layer 5.

Then, while the protective layer 5 was pressed, ultraviolet rays of 15 mW/cm² were radiated for five minutes. Thus, a color rewritable thermosensible recording layer 4 with a thickness of 15 μm was formed.

In the third example, a part of the recording layer 4 where writing by use of a thermal head was performed at 120° C. became transparent. The other parts which were left in a translucent scattering state became white, and a black image with a good contrast to the white background could be obtained. When writing by use of a thermal head was performed at 87° C., 95° C. and 115° C., a red image, a green image and a blue image could be obtained, respectively, and each of the images had a good contrast to the white background. When the recording medium passed between heat rollers which were heated to 120° C. and thereafter cooled slowly, the entire surface of the recording layer 4 came to a translucent scattering state.

Fourth Example of the Tenth Embodiment

Perylene pigment, which serves as a light absorbent, was dispersed in silicone resin (YR3370 made by Toray Industries, Inc.), and this was dissolved in an isopropyl alcohol solution mixed with a catalyst (CR15 made by Toshiba Silicone). This solution was coated on a sheet of quality paper and was dried to be made into a red intermediate layer 3 with a thickness of 3 μm. Next, the liquid crystal compound of the chemical formula (A) and bifunctional acrylate R712 (made by Nippon Kayaku Co., Ltd.) with an aromatic ring containing a photopolymerization initiator DAROCUR1173 (Chiba-Geigy (Japan)) at 3 wt % were mixed with each other at a ratio by weight of 8 to 2. Thus, a liquid crystal mixture was prepared. This liquid crystal mixture was coated on the intermediate layer 3, and ultraviolet rays of 0.02 mW/cm² were radiated for one hour. Further, ultraviolet rays of 0.25 mW/cm² were radiated for another hour. Thereby, a color composite film (rewritable thermosensible recording layer 4) with a thickness of 20 μm was formed.

In the fourth example, a part of the recording layer 4 where writing by use of a thermal head wass performed at 120° C. became transparent. The other parts which were left in a translucent scattering state became white, and a red image with a good contrast to the white background could be obtained. When the recording medium 1G passed between heat rollers which were heated to 120° C. and thereafter was cooled slowly, the entire surface of the recording layer 4 came to a translucent scattering state.

### Eleventh Embodiment; See FIG. 16

As FIG. 16 shows, a recording medium 1H as the eleventh embodiment is of the structure wherein the intermediate layer 3 of the tenth embodiment is omitted. The base layer 2, the recording layer 4 and the protective layer 5 used for the tenth embodiment can be used for this eleventh embodiment.

As described in connection with the tenth embodiment, if a light absorbing material is used for the base layer 2, by making the entire surface of the recording layer 4 come to a translucent scattering state and thereafter performing writing by use of a thermal head for the respective colors, a quality full-color image can be obtained on a white background. Also, if a material which reflects part of visible light is used for the base layer 2, by making the entire surface of the recording layer 4 come to a translucent scattering state and thereafter performing writing by use of a thermal head for transparence, an image of the color reflected by the base layer 2 can be reproduced well on a white background. In this case, the base layer 2 is preferably opaque.

### Twelfth Embodiment

According to the twelfth embodiment, a near infrared ray absorbent is dispersed in the intermediate layer 3 and/or the protective layer 5 of the tenth embodiment shown by FIGS. 15a and 15b so that the intermediate layer 3 and/or the protective layer 5 can have a function of converting infrared rays into heat. Otherwise, the intermediate layer 3 and/or the protective layer 5 may be made of an infrared ray absorbing material. The twelfth embodiment, although not shown in the drawings, imparts a function of absorbing infrared rays to the periphery of the recording layer 4, and information can be written in a recording medium of the twelfth embodiment effectively by use of the laser printer shown by FIG. 14.

### Other Embodiments

As the low molecular cholesteric liquid crystal compound to be a component of the recording layer, various ones as well as the one of the chemical formula (A) can be used.

Thermal printers and laser printers of various structures as well as the ones shown by FIGS. 7, 9, 12 and 14 can be used to write information in the recording media.

Although the present invention has been described in connection with the preferred embodiments above, it is to be noted that various changes and modifications are possible to those who are skilled in the art. Such changes and modifications are to be understood as being within the scope of the present invention.

What is claimed is:

1. An image bearing medium comprising:
a substrate which is flexible; and
a first image bearing layer disposed on the substrate, said first image bearing layer containing a low molecular compound which selectively exhibits a solid phase and a thermosensible cholesteric liquid crystal phase depending on a temperature thereof, wherein the low molecular compound changes from the thermosensible cholesteric liquid crystal phase to the solid phase with keeping a state set in the thermosensible cholesteric liquid crystal phase by rapidly changing the temperature thereof.

2. An image bearing medium as claimed in claim 1, wherein the low molecular compound changes from the thermosensible choresteric liquid crystal phase to the solid phase without keeping the state by gradually changing the temperature thereof.

3. An image bearing medium as claimed in claim 2, wherein the low molecular compound scatters light in a case where the low molecular compound has been changed from the thermosensible choresteric liquid crystal phase to the solid phase by gradually changing the temperature thereof.

4. An image bearing meadium as claimed in claim 1, wherein said substrate has a first side on which said first image bearing layer is disposed and a second side opposing the first side, said image bearing medium further comprising:
a second image bearing layer disposed on said second side, the second image bearing layer containing the low molecular compound.

5. An image bearing medium as claimed in claim 1, wherein the low molecular compound exhibits the solid phase when the temperature of the low molecular compound is lower than a first temperature, and exhibits the thermosensitive cholesteric liquid crystal phase when the temperature of the low molecular compound is in a range from a second temperature to a third temperature, both of the second temperature and the third temperature being higher than the first temperature.

6. An image bearing medium as claimed in claim 1, wherein said first image bearing layer is a composite of the low molecular compound and a resin material.

7. An image bearing medium as claimed in claim 6, wherein the first image bearing layer is separated into sections by the resin material.

8. An image bearing medium as claimed in claim 1, wherein said first image bearing layer further containing spacers for keeping a thickness of the first image bearing layer.

9. An image bearing medium as claimed in claim 1, wherein said substrate is transparent.

10. An image bearing medium comprising:
a substrate;
a light absorbing layer disposed on said substrate, said light absorbing layer absorbing at least one component of light entering thereto; and
an image bearing layer disposed on said light absorbing layer, said image bearing layer containing a low molecular compound which selectively exhibits a solid phase and a thermosensible cholesteric liquid crystal phase depending on a temperature thereof, wherein the low molecular compound changes from the thermosensible cholesteric liquid crystal phase to the solid phase with keeping a state set in the thermosensible cholesteric liquid crystal phase by rapidly changing the temperature thereof.

11. An image bearing medium as claimed in claim 10, wherein said light absorbing layer absorbs a visible light component of the light.

12. An image bearing medium as claimed in claim 10, wherein said image bearing layer is a composite of the low molecular compound and a resin material.

13. An image bearing medium as claimed in claim 12, wherein the first image bearing layer is separated into sections by the resin material.

14. An image bearing medium comprising:
a substrate having a first surface;
an intermediate layer disposed on said first surface, said intermediate layer having a second surface which is smoother than said first surface; and
an image bearing layer disposed on said second surface, said image bearing layer containing a low molecular compound which selectively exhibits a solid phase and a thermosensible cholesteric liquid crystal phase depending on a temperature thereof, wherein the low molecular compound changes from the thermosensible cholesteric liquid crystal phase to the solid phase with keeping a state set in the thermosensible cholesteric liquid crystal phase by rapidly changing the temperature thereof.

15. An image bearing medium as claimed in claim 14, wherein said intermediate layer absorbs at least one component of light entering thereto.

16. An image bearing medium as claimed in claim 15, wherein said intermediate layer absorbs a visible light component of the light.

17. An image bearing medium comprising:
a substrate; and
an image bearing layer disposed on said substrate, said image bearing layer containing a low molecular compound and a keeping member for keeping a thickness of said image bearing layer, the low molecular compound selectively exhibiting a solid phase and a thermosensible cholesteric liquid crystal phase depending on a temperature thereof, wherein the low molecular compound changes from the thermosensible cholesteric liquid crystal phase to the solid phase with keeping a state set in the thermosensible cholesteric liquid crystal phase by rapidly changing the temperature thereof.

18. An image bearing medium as claimed in claim 17, wherein said keeping member includes spacers dispersed in said image bearing layer.

19. An image bearing medium as claimed in claim 17, wherein:
said image bearing layer is a composite of the low molecular compound and a resin material; and
said keeping member is formed of the resin material.
